(19) United States
(12) Patent Application Publication
(10) Pub. No.: US 2014/0160792 A1
(43) Pub. Date: Jun. 12, 2014

(54) BACKLIGHT MODULE HAVING OPTICAL FIBERS

(71) Applicant: HON HAI PRECISION INDUSTRY CO., LTD., NEW TAIPEI (TW)

(72) Inventor: PO-CHOU CHEN, NEW TAIPEI (TW)

(73) Assignee: HON HAI PRECISION INDUSTRY CO., LTD., NEW TAIPEI (TW)

(21) Appl. No.: 13/851,080

(22) Filed: Mar. 26, 2013

(30) Foreign Application Priority Data
Dec. 7, 2012 (TW) 101146279

(51) Int. Cl. F21V 8/00

(52) U.S. Cl. CPC G02B 6/0036; G02B 6/0005
USPC 362/610

(57) ABSTRACT

A backlight module includes a light guide plate, a light source emitting light rays, and an optical fiber group corresponding to the light source. The light source has a light luminance surface. The light guide plate has a light incident surface. The optical fiber group has a number of optical fibers. Each of the optical fibers has a first end and a second end. The first end directly contacts with the light emitting surface. The second end directly contacts with the light incident surface, and thus the light rays from the second end directly enter the light guide plate through the light incident surface.

### BACKGROUND

1. Technical Field

The present disclosure relates to backlight modules, and particularly to a backlight module having optical fibers.

2. Description of Related Art

Currently, in a backlight module, a light incident surface of a light guide plate is greater than a luminance area of a single light source (such as a light emitting diode). Therefore, a portion of the light incident surface cannot receive the light rays. To overcome this problem, a number of light sources need to be positioned on a same side of the light incident surface to make sure the brightness distribution of a light emitting surface of the light guide plate is uniform, which will need more electrical energy.

Therefore, it is desirable to provide a backlight module that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a backlight module, according to a first exemplary embodiment.

FIG. 2 is a schematic view of a backlight module, according to a second exemplary embodiment.

### DETAILED DESCRIPTION

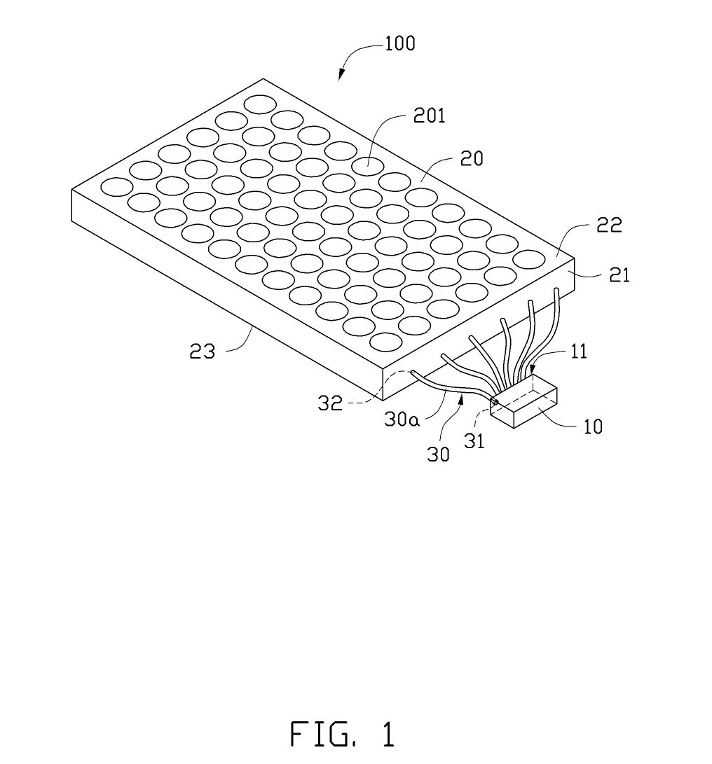

FIG. 1 illustrates a backlight module 100 in accordance to a first embodiment. The backlight module 100 includes a light source 10, a light guide plate 20, and an optical fiber group 30.

The light source 10 is used for emitting light rays, and includes a light luminous surface 11. In this embodiment, the light source 10 is a light emitting diode.

The light guide plate 20 is integrally formed, and is made of transparent material (such as acrylic resin or polyethylene resin). The light guide plate 20 includes a light incident surface 21, a light emitting surface 22 perpendicularly connected to the light incident surface 21, and a bottom surface 23 opposite to the light emitting surface 22. The light incident surface 21 faces the light luminous surface 11. The light incident surface 21 is used for transmitting the light rays from the light source 10 into the light guide plate 20. The light emitting surface 22 transmits a portion of the light rays incident thereon to the exterior above the light guide plate 20, and reflects the other portion of the light rays incident thereon back into the light guide plate 20. The bottom surface 23 is used for totally reflecting the light rays arriving thereon.

The light emitting surface 22 defines a number of semi-spherical micro recesses 201. In other embodiments, each of the micro recesses 201 also can be spherical crown shaped. Because the distance between the micro recesses 201 and the bottom surface 23 is shorter than the distance between the light emitting surface 22 and the bottom surface 23, the light rays can be directly reflected to the light bottom surface 23 by the micro recess 201 when the light rays is transmitted. Thus, the transmission path of the light rays becomes shorter, the energy loss of the light rays is reduced, and the brightness of the light emitting surface 22 is improved.

The optical fiber group 30 is used for directly guiding the light rays from the light source 10 to the light incident surface 21. The optical fiber group 30 includes a number of optical fibers 30a. Each optical fiber 30a includes a first end 31 and a second end 32 opposite to the first end 31. The first ends 31 directly contacts with the light luminous surface 11, and are used for receiving the light rays from the light source 10. The second ends 32 directly contacts with the light incident surface 21, and are evenly spaced with each other, and thus all of the light rays from the second ends 32 can reach the light incident surface 21. Therefore, the optical coupling efficiency can be improved.

The light transmitting path of the backlight module 100 is as follows: the light rays from the light sources 10 enter the optical fibers 30a through the first ends 31, and then are transmitted to the second end 32 by the optical fibers 30a. The light rays from the second ends 32 directly arrive at the light incident surface 21, and then enter the light guide plate 20. The light rays are transmitted in the light guide plate 20, and are emitted from the light emitting surface 22.

In other embodiments, because the optical fiber 30a can be properly bent in a range, and thus the light incident surface 21 also can be unaligned with the light luminous surface 11.

In other embodiments, the light incident surface 21 also can define a number of micro-structures to make the brightness of the light rays from the light emitting surface 22 to be distributed more uniformly.

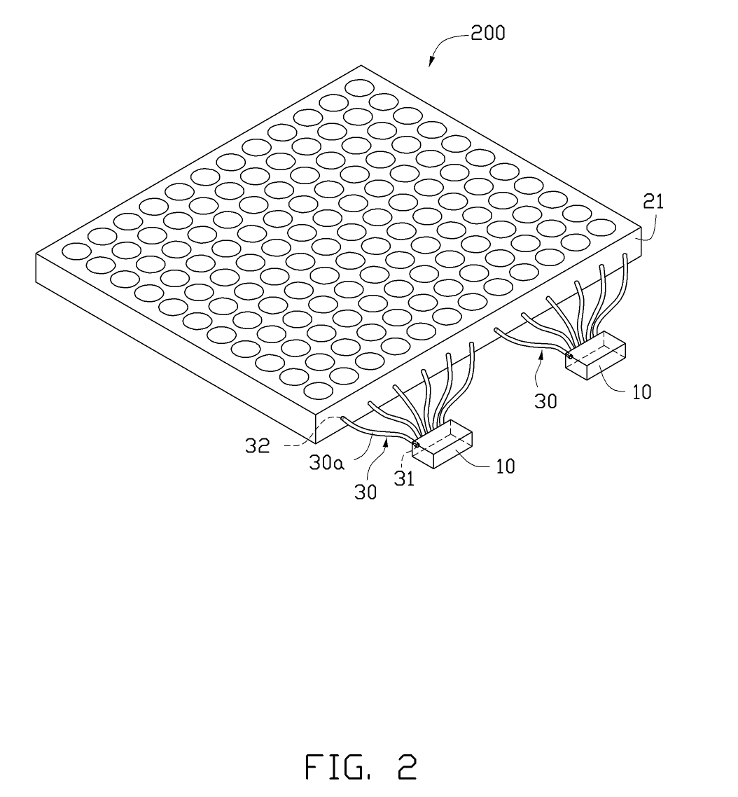

FIG. 2 shows the backlight module 200 according to a second embodiment. The difference between the backlight module 200 of FIG. 2 and the backlight module 100 of FIG. 1 is that the backlight module 200 includes two of the light sources 10 and two of the optical fiber groups 30 corresponding to the two light sources 10. In this embodiment, the numbers of the optical fibers 30a of the two optical fiber groups 30 are the same. In other embodiments, the numbers of the optical fibers 30a of the two optical fiber groups 30 also can be different from each other.

The first ends 31 of each optical fiber group 30 directly contact with the corresponding light source 10. The second ends 32 of each optical fiber groups 30 directly contact with the light incident surface 21, and are evenly spaced with each other. The smallest distance between the two optical fiber groups 30 is equal to the distance between the second ends 32 of every two adjacent optical fibers 30a of each optical fiber group 30.

In other embodiments, the number of the light source 10 and the number of the optical fiber group 30 are not limited to this embodiment.

By employing the backlight module, one light source becomes a number of small light sources through the optical fibers, and the brightness distribution of the small light sources are more uniform than the brightness distribution of the light source. Therefore, the light rays emitted from the light emitting surface are distributed more uniformly. At the same time, the number of the light source is reduced when the light incident surface is unchanged, and thus the electrical power is reduced.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A backlight module, comprising:
a light source for emitting light rays, the light source having a light luminance surface;
a light guide plate having a light incident surface, and
an optical fiber group corresponding to the light source and configured for transmitting the light rays from the light source to the light guide plate, the optical fiber group having a plurality of optical fibers, each of the optical fibers having a first end and a second end, the first end directly contacting with the light luminance surface, the second end directly contacting with the light incident surface, and thus the light rays from the second end directly entering the light guide plate through the light incident surface.

2. The backlight module of claim 1, wherein the light luminance surface faces the light incident surface.

3. The backlight module of claim 1, wherein the second ends of the optical fibers are evenly spaced and separated from each other.

4. The backlight module of claim 1, wherein the light guide plate comprises a light emitting surface perpendicularly connected to the light incident surface.

5. The backlight module of claim 1, wherein the light emitting surface defines a plurality of micro recesses arranged in an array, and the micro recesses are semi-spherical shaped.

6. The backlight module of claim 1, wherein the light emitting surface defines a plurality of micro recesses arranged in an array, and the micro recesses are spherical crown shaped.

7. The backlight module of claim 1, wherein the light source is a light emitting diode.
